(19) United States
(12) Patent Application Publication
(10) Pub. No.: US 2024/0009905 A1
(43) Pub. Date: Jan. 11, 2024

(54) STATE DETERMINATION DEVICE AND STATE DETERMINATION METHOD

(71) Applicant: FANUC CORPORATION, Yamanashi (JP)

(72) Inventor: Atsushi HORIUCHI, Yamanashi (JP)

(21) Appl. No.: 18/245,897

(22) PCT Filed: Sep. 30, 2021
(86) PCT No.: PCT/JP2021/036167

§ 371 Date: Mar. 20, 2023

(30) Foreign Application Priority Data
Oct. 5, 2020 (JP) 2020-168771

(51) Int. Cl. B29C 45/76

(52) U.S. Cl. CPC B29C 45/768; B29C 2945/76003

(57) ABSTRACT

A state determination device includes a data acquisition unit configured to acquire data related to a predetermined physical quantity as data indicating a state related to an injection molding machine, a feature amount calculation unit configured to calculate a feature amount indicating a feature of a state of the injection molding machine based on the data related to the physical quantity, a statistical data calculation unit configured to calculate a statistic as statistical data according to a statistical condition including at least a statistical function for calculating a predetermined statistic from a predetermined feature amount based on a calculated feature amount, and a state determination unit configured to determine a state of the injection molding machine based on fluctuation of a plurality of pieces of consecutive statistical data.

### TECHNICAL FIELD

The present invention relates to a state determination device and a state determination method related to an injection molding machine, and more particularly to a state determination device and a state determination method that assist in determining quality of a molded product molded by an injection molding machine.

### BACKGROUND ART

In production of a molded product by an injection molding machine, a determination condition related to molding is set in advance, and quality of the molded product is determined using the determination condition. For example, when a production lot of resin that is a material of the molded product is changed, a plasticization state of resin in an injection cylinder fluctuates, which may cause a defect in the molded product. In addition, a defect may occur in the molded product due to wear of a part such as a screw and running out of grease in a movable portion. Therefore, a state of the injection molding machine, which fluctuates due to a change over time or an environmental change, is determined based on changes in an injection time or peak pressure in an injection process, and in a feature amount such as a weighing time or a weighing position in a weighing process in a molding cycle.

Even when there is a slight difference in the feature amount compared to the feature amount when the plasticization state of the resin is optimal, as long as the difference is not significant, an abnormality does not necessarily occur in the molded product. Therefore, it is common to provide a permissible range for the determination condition of the feature amount. For example, Patent Document 1 discloses that quality determination is performed based on maximum and minimum values of measurement data detected in each molding cycle. In addition, Patent Documents 2 to 4 disclose that a feature amount (for example, actual value/operation data of an injection time, peak pressure, a weighting position, etc.) is calculated from time-series data, normality (non-defective product) or abnormality (defective product) is determined based on a permissible range of a reference value, a deviation from the reference value, an average value, a standard deviation, etc. related to the calculated feature amount, and information thereof is reported as an alarm (possibility that abnormality occurs in the product).

### CITATION LIST

### Patent Document

Patent Document 1: JP H02-106315 A

Patent Document 2: JP H06-231327 A

Patent Document 3: JP 2002-079560 A

Patent Document 4: JP 2003-039519 A

### DISCLOSURE OF THE INVENTION

### Problem to be Solved by the Invention

There are various factors that cause abnormality (defect) in a molded product, including accidental factors and medium and long-term factors. Examples of the accidental factors include sensor breakage, intrusion of foreign matter into a movable portion, intrusion of foreign matter into a production material, an operation error of an operator, etc. Meanwhile, examples of the medium and long-term factors include abrasion, wear, and deterioration of a mechanical member (abrasion of a screw, wear of a belt, running out of grease in a movable portion, aged deterioration of an electrical component, abrasion of a mold, etc.), a change in a production environment (deterioration of a production material (resin), seasonal change, humidity change due to rainfall etc., temperature changes in the morning, afternoon, and evening, etc.), etc. For example, the temperature changes in the morning, afternoon, and evening affect temperature control for heating an injection cylinder, and a plasticization state of resin in the injection cylinder may fluctuate, leading to a defective molded product.

In this way, even when operating conditions of a machine (program, a parameter such as injection speed) are the same, a feature amount calculated from measurement data fluctuates and varies due to environmental fluctuation such as a temperature fluctuation and a change over time. Conventionally, with regard to abnormality related to accidental and short-term factors, a molding state can be determined by providing a threshold value such as a predetermined upper limit value or lower limit value for a measured value acquired in each molding cycle, or a feature amount or a statistic calculated from the measured value.

However, determining a molding state that changes slowly over a long period of time, and detecting a sign of change in a state that gradually changes over time to predict a change in a future state have not been sufficiently addressed.

That is, there is a demand for preventive maintenance for reporting breakdown of a machine before the breakdown, reporting a state of a molded product before the molded product becomes defective, and improving an operating rate.

### Means for Solving Problem

A state determination device according to the invention calculates a feature amount of time-series data (such as a peak value in a molding process) for each molding process based on time-series data (for example, pressure, current, speed, etc.) related to a molding operation of an injection molding machine, and calculates a statistic using a statistical function for a plurality of calculated feature amounts. Subsequently, a molding state of the injection molding machine is determined based on fluctuation of the plurality of calculated statistics.

Further, an aspect of the invention is a state determination device for determining a state of an injection molding machine, the state determination device including a data acquisition unit configured to acquire data related to a predetermined physical quantity as data indicating a state related to the injection molding machine, a feature amount calculation unit configured to calculate a feature amount indicating a feature of a state of the injection molding machine based on the data related to the physical quantity, a feature amount storage unit configured to store the feature amount, a statistical condition storage unit configured to store a statistical condition including at least a statistical function for calculating a predetermined statistic from a predetermined feature amount, a statistical data calculation unit configured to calculate a statistic as statistical data with reference to a statistical condition stored in the statistical condition storage unit based on the feature amount stored in the feature amount storage unit, a statistical data storage unit configured to store the statistical data, and a state determination unit configured to determine a state of the injection molding machine based on fluctuation of a plurality of pieces of consecutive statistical data in the statistical data stored in the statistical data storage unit.

Another aspect of the invention is a state determination method of determining a state of an injection molding machine, the state determination method executing a step of acquiring data related to a predetermined physical quantity as data indicating a state related to the injection molding machine, a step of calculating a feature amount indicating a feature of a state of the injection molding machine based on data related to the physical quantity, a step of calculating a statistic as statistical data according to a statistical condition including at least a statistical function for calculating a predetermined statistic from a predetermined feature amount based on the calculated feature amount, and a step of determining a state of the injection molding machine based on fluctuation of a plurality of pieces of consecutive statistical data in the calculated statistical data.

### Effect of the Invention

According to one aspect of the present invention, it is possible to determine a molding state that gradually changes over a long period of time, and further to predict a future change in the state.

### BRIEF DESCRIPTION OF DRAWINGS

FIG. 1 is a schematic hardware configuration diagram of a state determination device according to an embodiment;

FIG. 2 is a schematic configuration diagram of an injection molding machine;

FIG. 3 is a schematic functional block diagram of a state determination device according to a first embodiment;

FIG. 4 is a diagram illustrating an example of a molding cycle for manufacturing one molded product;

FIG. 5 is a diagram illustrating an example of calculating a feature amount from one piece of time-series data;

FIG. 6 is a diagram illustrating an example of calculating a feature amount from two or more pieces of time-series data;

FIG. 7 is a diagram illustrating an example of statistical conditions;

FIG. 8A is a diagram illustrating a graph in which a feature amount for each shot is plotted;

FIG. 8B is a diagram illustrating a graph in which statistical data calculated from a feature amount is plotted;

FIG. 9 is a diagram illustrating an example of statistical data stored in a statistical data storage unit;

FIG. 10 is a schematic functional block diagram of a state determination unit when determining a state of the injection molding machine by statistical analysis;

FIG. 11 is a diagram illustrating an example of a determination condition;

FIG. 12 is a schematic functional block diagram of the state determination unit when determining a state of the injection molding machine by machine learning;

FIG. 13 is a diagram illustrating an example of a learning model; and

FIG. 14 is a diagram illustrating an example of an input screen for statistical conditions.

### MODE(S) FOR CARRYING OUT THE INVENTION

Hereinafter, embodiments of the invention will be described with reference to the drawings.

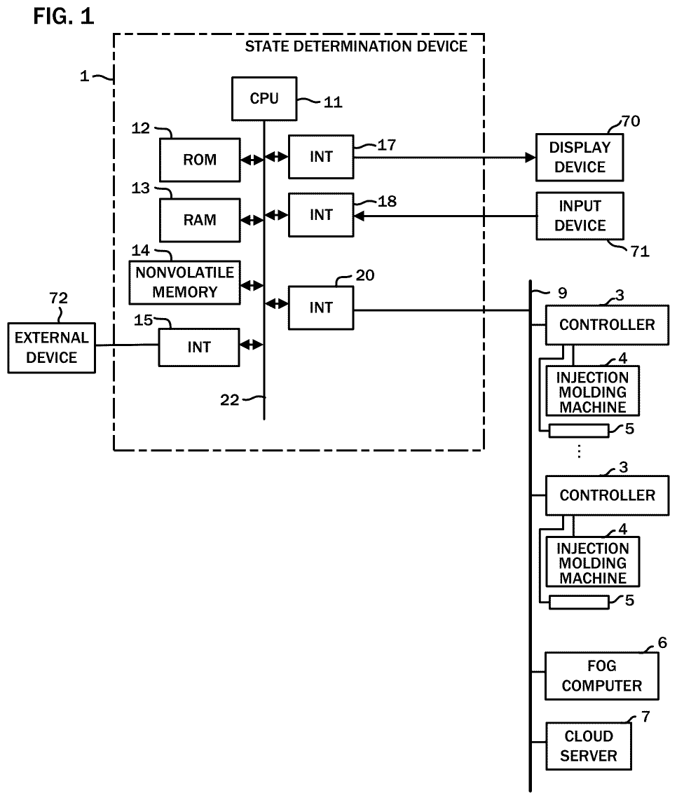

FIG. 1 is a schematic hardware configuration diagram illustrating essential parts of a state determination device according to an embodiment of the invention. For example, the state determination device 1 according to the present embodiment may be mounted as a controller that controls an injection molding machine 4 based on a control program. Further, the state determination device 1 according to the present embodiment may be mounted in a host device such as a personal computer installed side by side with a controller that controls the injection molding machine 4 based on a control program, a personal computer connected to the controller via a wired/wireless network, a cell computer, a fog computer 6, or a cloud server 7. In the present embodiment, an example in which the state determination device 1 is mounted on a personal computer connected to a controller 3 via a network 9 is illustrated.

A CPU 11 included in the state determination device 1 according to the present embodiment is a processor that controls the state determination device 1 as a whole. The CPU 11 reads a system program stored in a ROM 12 via a bus 22 and controls the entire state determination device 1 according to the system program. A RAM 13 temporarily stores temporary calculation data, display data, various data input from the outside, etc.

For example, a nonvolatile memory 14 includes a memory backed up by a battery (not illustrated), an SSD (Solid State Drive), etc. and retains a storage state even when power of the state determination device 1 is turned off. The nonvolatile memory 14 stores data read from an external device 72 via an interface 15, data input from an input device 71 via an interface 18, data acquired from the injection molding machine 4 via the network 9, etc. For example, the stored data may include data related to physical quantities such as a motor current, voltage, torque, position, speed, and acceleration of a driving unit, pressure in a mold, a temperature of the injection cylinder, a flow rate of resin, a flow velocity of resin, and vibration and sound of the driving unit detected by various sensors 5 attached to the injection molding machine 4 controlled by the controller 3. The data stored in the nonvolatile memory 14 may be loaded in the RAM 13 during execution/use. Further, various system programs such as well-known analysis programs are pre-written to the ROM 12.

The interface 15 is an interface for connecting the CPU 11 of the state determination device 1 and the external device 72 such as an external storage medium. From the external device 72 side, for example, a system program, a program, parameters, etc. related to an operation of the injection molding machine 4 can be read. In addition, data, etc. created/edited on the state determination device 1 side may be stored in the external storage medium such as a CF card or a USB memory (not illustrated) via the external device 72.

An interface 20 is an interface for connecting the CPU of the state determination device 1 and the wired or wireless network 9. For example, the network 9 may perform communication using techniques such as serial communication such as RS-485, Ethernet (registered trademark) communication, optical communication, wireless LAN, Wi-Fi (registered trademark), Bluetooth (registered trademark), etc. The controller 3 for controlling the injection molding machine 4, the fog computer 6, the cloud server 7, etc. are connected to the network 9, and data is exchanged with the state determination device 1.

Each piece of data read on a memory, data obtained as a result of execution of a program, etc. are output and displayed on a display device 70 via an interface 17. In addition, the input device 71 including a keyboard, a pointing device, etc., transfers commands, data, etc. based on an operation by an operator to the CPU 11 via the interface 18.

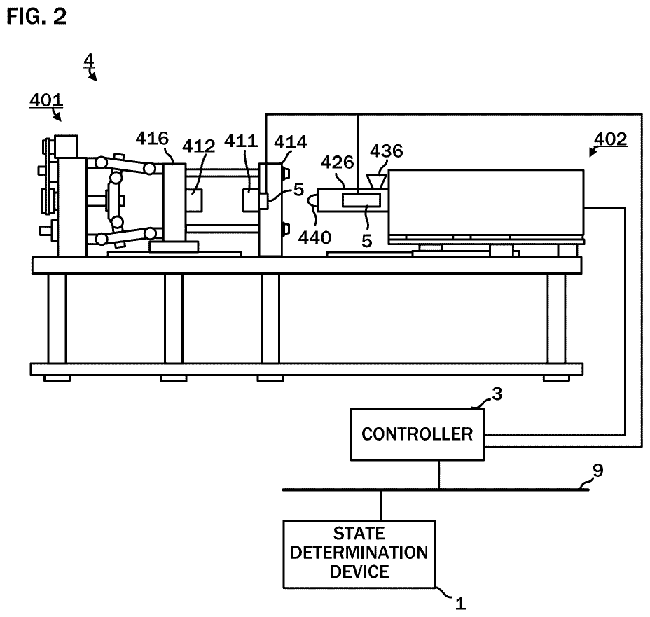

FIG. 2 is a schematic configuration diagram of the injection molding machine 4. The injection molding machine 4 mainly includes a mold clamping unit 401 and an injection unit 402. The mold clamping unit 401 includes a movable platen 416 and a stationary platen 414. In addition, a movable mold 412 is attached to the movable platen 416, and a stationary mold 411 is attached to the stationary platen 414. Meanwhile, the injection unit 402 includes an injection cylinder 426, a hopper 436 for storing a resin material supplied to the injection cylinder 426, and a nozzle 440 provided at a tip of the injection cylinder 426. In a molding cycle for manufacturing one molded product, the mold clamping unit 401 performs mold closing/mold clamping operations by moving the movable platen 416, and the injection unit 402 presses the nozzle 440 against the stationary mold 411 and then injects resin into the mold. These operations are controlled by commands from the controller 3.

In addition, the sensors 5 are attached to respective portions of the injection molding machine 4, and physical quantities such as a motor current, voltage, torque, position, speed, and acceleration of the driving unit, pressure in the mold, a temperature of the injection cylinder 426, a flow rate of resin, a flow velocity of resin, and vibration and sound of the driving unit are detected and sent to the controller 3. In the controller 3, each of the detected physical quantities is stored in the RAM, the nonvolatile memory, etc. (not illustrated), and is transmitted to the state determination device 1 via the network 9 as necessary.

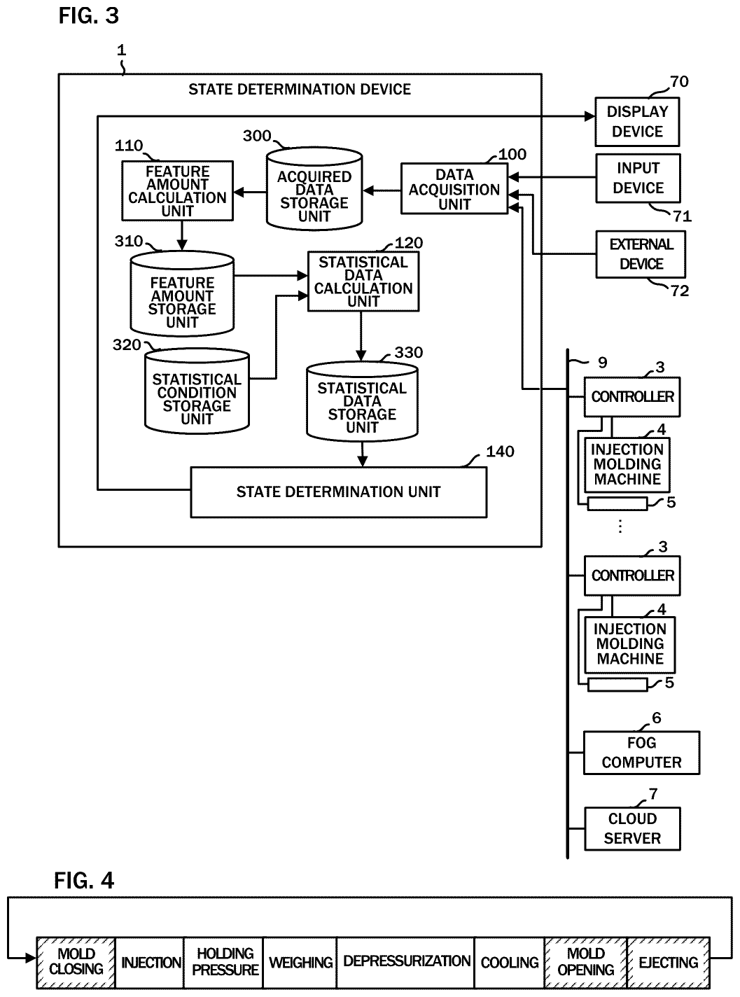

FIG. 3 is a schematic block diagram illustrating a function of the state determination device 1 according to a first embodiment of the present invention. Each function provided in the state determination device 1 according to the present embodiment is realized by the CPU 11 provided in the state determination device 1 illustrated in FIG. 1 executing a system program and controlling an operation of each unit of the state determination device 1.

The state determination device 1 of the present embodiment includes a data acquisition unit 100, a feature amount calculation unit 110, a statistical data calculation unit 120, and a state determination unit 140. In addition, in the RAM 13 or the nonvolatile memory 14 of the state determination device 1, an acquired data storage unit 300 as an area for storing data acquired by the data acquisition unit 100 from the controller 3, etc., a feature amount storage unit 310 as an area for storing a feature amount calculated by the feature amount calculation unit 110, a statistical condition storage unit 320 for pre-storing a statistical condition in calculation of statistical data by the statistical data calculation unit 120, and a statistical data storage unit 330 as an area for storing statistical data calculated by the statistical data calculation unit 120 are prepared in advance.

The data acquisition unit 100 is realized by the CPU 11 provided in the state determination device 1 illustrated in FIG. 1 executing a system program read from the ROM 12, and mainly performing arithmetic processing by the CPU 11 using the RAM 13 and the nonvolatile memory 14 and input control processing by the interface 15, 18, or 20. The data acquisition unit 100 acquires data related to the physical quantities such as the motor current, voltage, torque, position, speed, and acceleration of the driving unit, the pressure in the mold, the temperature of the injection cylinder 426, the flow rate of resin, the flow velocity of resin, and vibration and sound of the driving unit detected by the sensors 5 attached to the injection molding machine 4. The data related to the physical quantities acquired by the data acquisition unit 100 may be so-called time-series data indicating values of the physical quantities for each predetermined cycle. When acquiring the data related to the physical quantities, the data acquisition unit 100 also acquires the number of productions (the number of shots) when the physical quantities are detected. The number of productions (the number of shots) may be the number of productions (number of shots) after performing previous maintenance. The data acquisition unit 100 may acquire data directly from the controller 3 that controls the injection molding machine 4 via the network 9. The data acquisition unit 100 may acquire data acquired and stored by the external device 72, the fog computer 6, the cloud server 7, etc. The data acquisition unit 100 may acquire data related to physical quantities for each process included in one molding cycle by the injection molding machine 4. FIG. 4 is a diagram illustrating a molding cycle for manufacturing one molded product. In FIG. 4, a mold closing process, a mold opening process, and an ejecting process, which are processes in hatched frames, are performed by an operation of the mold clamping unit 401. In addition, an injection process, a holding pressure process, a weighing process, a depressurization process, and a cooling process, which are processes outlined in white, are performed by an operation of the injection unit 402. The data acquisition unit 100 acquires data related to physical quantities so that each of these processes can be distinguished. The data related to the physical quantities acquired by the data acquisition unit 100 is stored in the acquired data storage unit 300 in association with the number of productions (number of shots) by the injection molding machine 4.

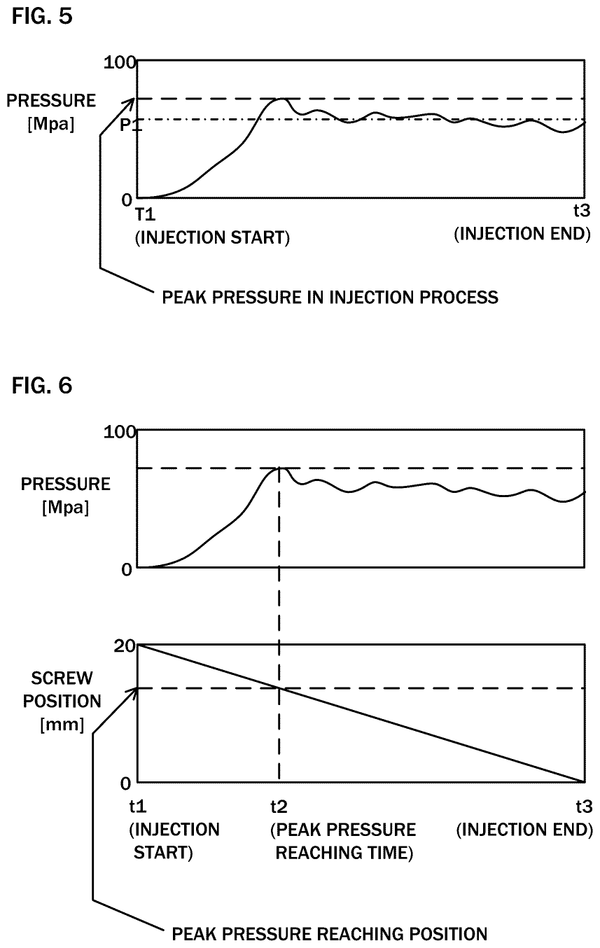

The feature amount calculation unit 110 is realized by the CPU 11 provided in the state determination device 1 illustrated in FIG. 1 executing a system program read from the ROM 12 and mainly performing arithmetic processing using the RAM 13 and the nonvolatile memory 14 by the CPU 11. The feature amount calculation unit 110 calculates a feature amount of data related to physical quantities (injection time, peak pressure, and a peak pressure reaching position in the injection process, a weighing pressure peak value and a weighing end position in the weighing process, a mold closing time in the mold closing process, a mold opening time in the mold opening process, etc.) for each process included in the molding cycle of the injection molding machine 4 based on data related to physical quantities indicating a state of the injection molding machine 4 acquired by the data acquisition unit 100. The feature amount calculated by the feature amount calculation unit 110 indicates a feature of a state of each process of the injection molding machine 4. FIG. 5 is a graph indicating a change in pressure during the injection process. In FIG. 5, t1 indicates a start time of the injection process, and t3 indicates an end time of the injection process. The pressure is controlled by the controller 3 of the injection molding machine 4 so that the pressure starts to rise as resin in the injection cylinder is injected into the mold, and then reaches a predetermined target pressure P1. The predetermined target pressure P1 is manually set in advance by the operator visually confirming an operation screen displayed on the display device 70 and operating the input device 71 as a command based on an operation of the operator. As illustrated in FIG. 5, the feature amount calculation unit 110 calculates a peak value of time-series data indicating the pressure acquired in the injection process, and uses the peak value as a feature amount of the peak pressure in the injection process. FIG. 6 is a graph illustrating a change in the pressure and a change in the screw position during the injection process. As illustrated in FIG. 6, the feature amount calculation unit 110 calculates the peak pressure in the injection process, then calculates a screw position at a peak pressure reaching time t2 at which the peak pressure is reached, and uses this screw position as a feature amount of a peak pressure reaching position in the injection process. In this way, the feature amount calculated by the feature amount calculation unit 110 may be calculated based on data related to a predetermined physical quantity in a predetermined process, or may be calculated from data related to a plurality of physical quantities in a predetermined process. The feature amount calculated by the feature amount calculation unit 110 is stored in the feature amount storage unit 310 in association with the number of productions (number of shots) by the injection molding machine 4.

The statistical data calculation unit 120 is realized by the CPU 11 provided in the state determination device 1 illustrated in FIG. 1 executing a system program read from the ROM 12 and mainly performing arithmetic processing by the CPU 11 using the RAM 13 and the nonvolatile memory 14. The statistical data calculation unit 120 calculates statistical data, which is a statistic of the feature amount, based on a feature amount indicating a feature of a state of the injection molding machine 4 calculated by the feature amount calculation unit 110. The statistical data calculation unit 120 refers to a statistical condition stored in the statistical condition storage unit 320 when calculating the statistical data.

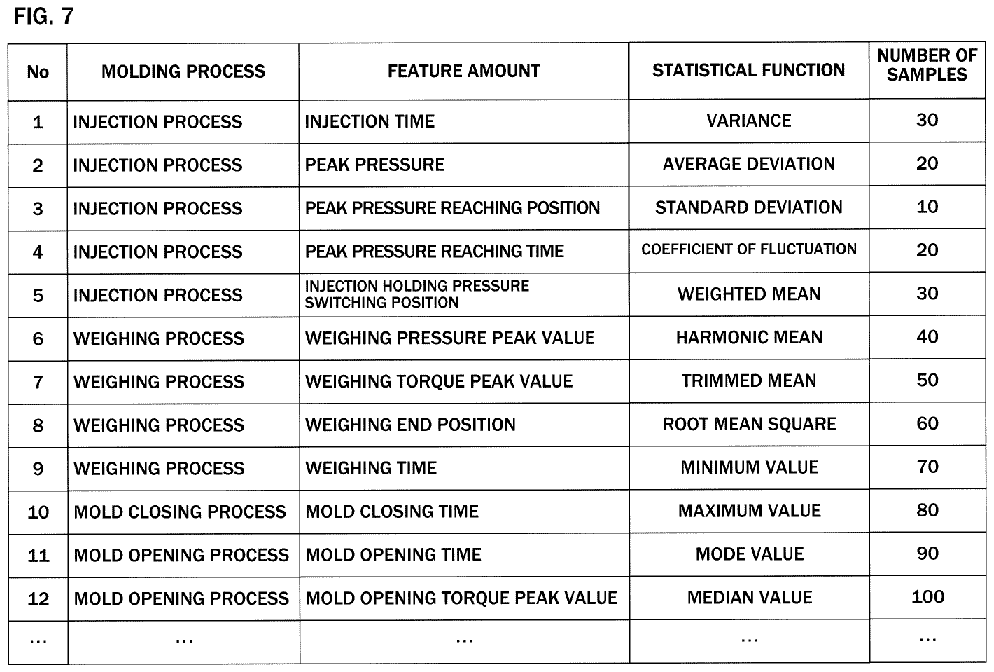

The statistical condition stored in the statistical condition storage unit 320 defines a condition for calculating a statistic (for example, an average value, a variance, etc.) from a feature amount. FIG. 7 illustrates an example of the statistical condition stored in the statistical condition storage unit 320. As illustrated in FIG. 7, the statistical condition associates a feature amount with a statistical function for calculating a statistic from the feature amount. As illustrated in FIG. 7, the statistical condition may be defined for each molding process included in a molding cycle to which the feature amount pertains. Further, as illustrated in FIG. 7, the statistical condition may include the number of samples of the feature amount when calculating the statistic. For example, the statistical function included in statistical condition may be a weighted mean, an arithmetic mean, a weighted harmonic mean, a harmonic mean, a trimmed mean, a logarithmic mean, a root mean square, a minimum value, a maximum value, a median value, a weighted median value, a mode value, etc. A test operation of the injection molding machine 4 may be performed in advance, a correlation between a molding state of a molded product by the injection molding machine 4 and each statistic calculated from the feature amount may be analyzed, and an appropriate statistical function may be selected as this statistical function based on an analysis result thereof. For example, when a maximum value of a predetermined feature amount changes as the molding state of the molded product by the injection molding machine 4 changes, the maximum value may be selected as a statistical function for calculating a statistic of the feature amount. In addition, for example, when an outlier that deviates significantly from an average value of a feature amount is included in a plurality of feature amounts, a weighted median value, a mode value, etc. less susceptible to an influence of the outlier may be selected as a statistical function. In addition, for example, when a value of a predetermined feature amount varies as the molding state of the molded product by the injection molding machine 4 changes, a standard deviation may be selected as a statistical function for calculating a statistic of the feature amount. Note that the statistical function when the value of the feature amount varies is not limited to the standard deviation, and may be a variance, an average deviation, a coefficient of fluctuation, etc. As such, it is desirable to select a statistical function useful for determining a change in the state of the injection molding machine 4 as the statistical condition related to the predetermined feature amount.

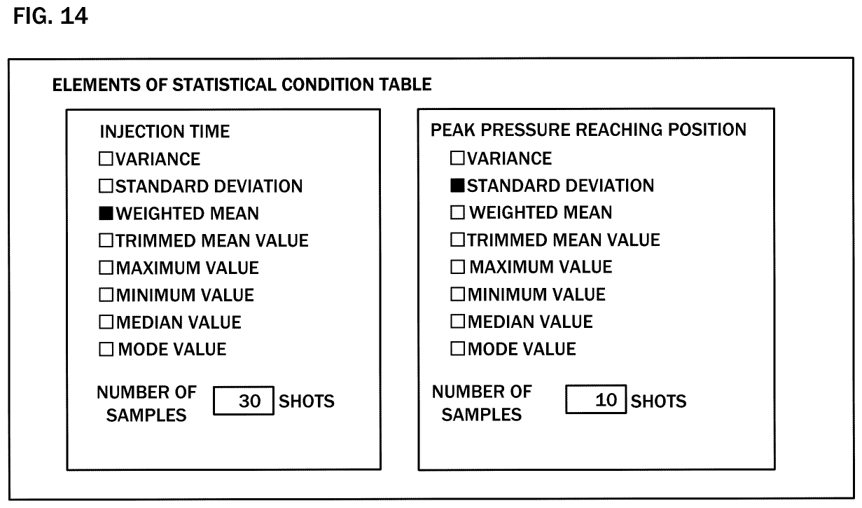

As illustrated in FIG. 14, the operator may manually set and update the statistical condition by operating the input device 71 from the operation screen displayed on the display device 70. FIG. 14 illustrates a display example when the operator selects a weighted average as a statistical function for calculating a statistic from the injection time of the feature amount, and selects a standard deviation as a statistical function for calculating a statistic from the peak pressure reaching position of the feature amount. In addition, the figure illustrates that the number of samples used by the statistical function to calculate the statistic is 30 shots in the case of the injection time of the feature amount and is 10 shots in the case of the peak pressure reaching position of the feature amount. As a method of determining the number of samples, a small value may be selected as the number of samples when the value of the feature amount changes with a small number of shots as in the case of the injection time or the peak pressure reaching position in the injection process, and a large value such as 90 shots may be selected as the number of samples when a value of a feature amount is stable for each molding cycle and changes little as in the case of the mold opening time in the mold opening process, or when the feature amount changes slowly over a large number of shots as in the case of the temperature of the injection cylinder. In this way, a different number of shots may be appropriately selected as the number of samples depending on how the feature amount changes for each molding cycle (for each shot).

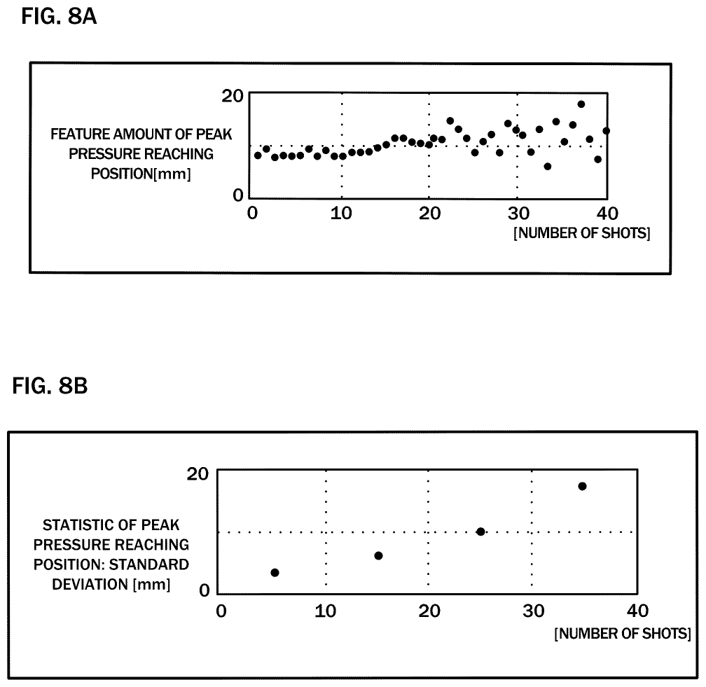

The statistical data calculation unit 120 refers to the statistical condition stored in the statistical condition storage unit 320 to calculate statistical data, which is a statistic of a feature amount, based on the feature amount stored in the feature amount storage unit 310 at a predetermined timing. For example, the statistical data calculation unit 120 may calculate statistical data for each predetermined molding cycle (every shot, every ten shots, every number of samples set in the statistical condition, etc.). FIGS. 8A and 8B illustrate examples of statistical data of the peak pressure reaching position. FIG. 8A is a graph plotting the feature amount for each shot, and FIG. 8B is a graph plotting statistical data calculated from the feature amount. As illustrated in FIG. 7, the statistical condition (statistical condition No. 3) for calculating statistical data of the peak pressure reaching position defines a standard deviation as the statistical function and 10 shots as the number of samples. At this time, the statistical data calculation unit 120 calculates a standard deviation of each feature amount of the peak pressure reaching position calculated for each shot separately every 10 shots, and uses a result thereof as the statistical data of the peak pressure reaching position. In addition, in the statistical condition (statistical condition No. 3), the injection process is defined as the molding process to which the feature amount pertains. Therefore, it is preferable that a timing at which the statistical data calculation unit 120 calculates the statistical data is set not to overlap with the injection process, that is, the statistical data is calculated in the mold opening process, the ejecting process, etc. which is a process after ending the injection process (see FIG. 4). The statistical data calculation unit 120 stores the statistical data calculated in this way in the statistical data storage unit 330. Note that, when determining the statistical function defined in the statistical condition, the operator may visually check a distribution state of the feature amount plotted in FIG. 8A and appropriately select the statistical function.

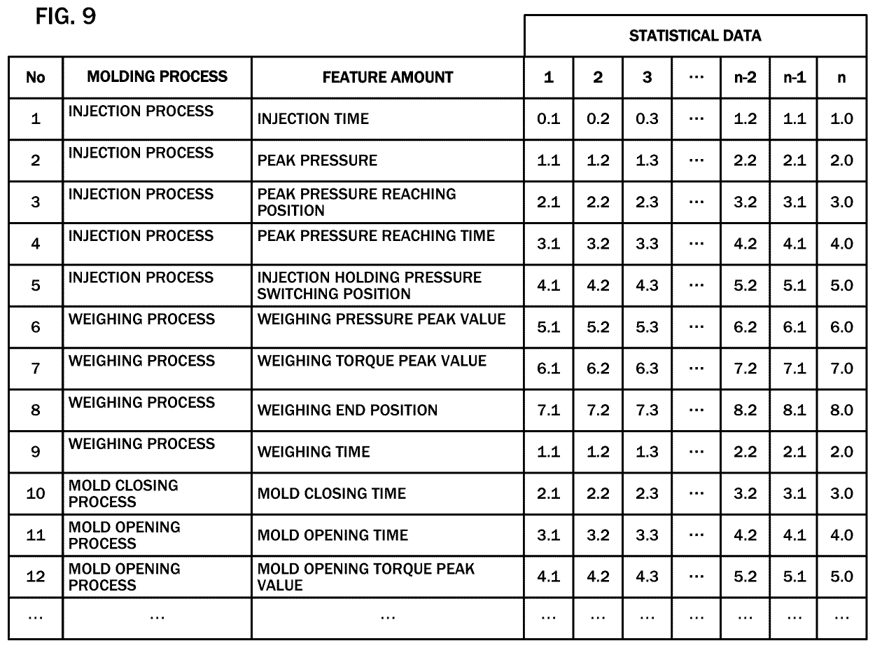

FIG. 9 illustrates an example of statistical data stored in the statistical data storage unit 330. In FIG. 9, each of count numbers from 1 to n corresponds to the number of times the statistical data is calculated. That is, in the example of FIG. 9, n pieces of statistical data are stored after calculating and storing the statistical data. In addition, each piece of statistical data is arranged so that statistical data calculated later has a larger count number. In this way, it is preferable that the statistical data calculated by the statistical data calculation unit 120 is stored in the statistical data storage unit 330 so that the calculation order, that is, the time order in which data related to physical quantities used as a basis for calculation is acquired, can be identified. By storing the statistical data so that the order of the statistical data can be identified, it becomes possible to execute a predetermined process on a plurality of pieces of consecutive statistical data.

The state determination unit 140 is realized by the CPU 11 provided in the state determination device 1 illustrated in FIG. 1 executing a system program read from the ROM 12 and mainly performing arithmetic processing by the CPU 11 using the RAM 13 and the nonvolatile memory 14. The state determination unit 140 determines the state of the injection molding machine 4 based on fluctuation of a plurality of pieces of consecutive statistical data in the statistical data stored in the statistical data storage unit 330. For example, the state determination unit 140 determines the state of the injection molding machine 4 depending on how five pieces of most recent statistical data of any one of an injection time, a weighing time, a mold closing time, and a mold opening time fluctuate. In another example, the state determination unit 140 determines the state of the injection molding machine 4 depending on how five pieces of most recent statistical data of any one of a weighing pressure peak value, a weighing torque peak value, and a weighing end position fluctuate.

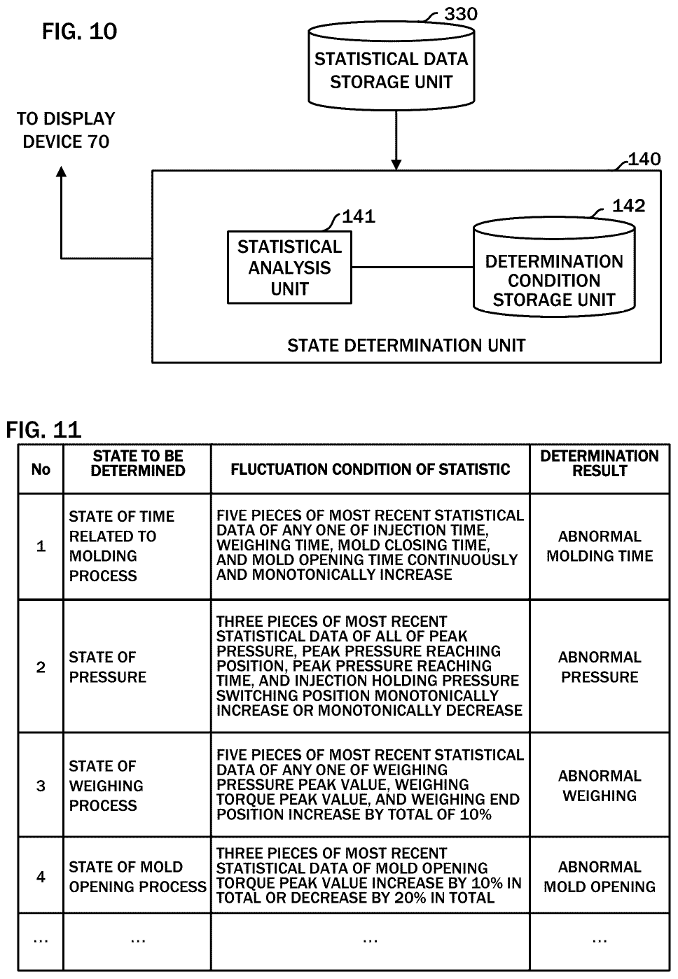

The state determination unit 140 may determine fluctuation by statistically analyzing a plurality of pieces of consecutive statistical data stored in the statistical data storage unit 330. FIG. 10 is a schematic block diagram illustrating functions of the state determination unit 140 when performing statistical analysis. The state determination unit 140 that performs statistical analysis includes a statistical analysis unit 141 and a determination condition storage unit 142.

The statistical analysis unit 141 statistically analyzes a plurality of pieces of consecutive statistical data based on the determination condition stored in the determination condition storage unit 142. FIG. 11 illustrates an example of the determination condition stored in the determination condition storage unit 142. The determination condition may be defined as a combination of a fluctuation condition of statistical data and a determination result when the condition is satisfied for each state to be determined. In the example of FIG. 11, a determination condition (determination condition No. 1) for determining “a state of time related to the molding process” defines that, when a condition that “five pieces of most recent statistical data of any one of the injection time, the weighing time, the mold closing time, and the mold opening time continuously and monotonically increase” is satisfied, a state of “abnormal molding time” is determined. When such a determination condition is defined, the statistical analysis unit 141 acquires five pieces of most recent statistical data for each of the injection time, the weighing time, the mold closing time, and the mold opening time each time new statistical data is calculated, and determines whether or not statistical data included in the acquired statistical data monotonically increases. Then, when any one of the injection time, the weighing time, the mold closing time, and the mold opening time monotonically increases, the state determination unit 140 determines that there is an abnormality in the molding time. In another example of FIG. 11, a determination condition (determination condition No. 3) for determining “a state of the weighing process” defines that, when a condition that “five pieces of most recent statistical data of any one of the weighing pressure peak value, the weighing torque peak value, and the weighing end position increase by a total of 10%” is satisfied, a state of “abnormal weighing” is determined. When such a determination condition is defined, the statistical analysis unit 141 acquires five pieces of most recent statistical data for each of the weighing pressure peak value, the weighing torque peak value, and the weighing end position each time new statistical data is calculated, and determines whether or not the increased amount of statistical data included in the acquired statistical data is 10% or more in total. Then, when any one of the weighing pressure peak value, the weighing torque peak value, and the weighing end position increases by 10% or more in total, the state determination unit 140 determines that there is an abnormality in the weighing process.

A determination result by the state determination unit 140 may be displayed on and output to the display device 70. Further, the state determination unit 140 may transmit and output the determination result to the controller 3 of the injection molding machine 4 or a host device such as the fog computer 6 or the cloud server 7 via the network 9. Furthermore, when the state determination unit 140 determines that there is an abnormality, the operation of the injection molding machine 4 may be suspended or decelerated, or driving torque of a prime mover that drives the driving unit of the injection molding machine 4 may be limited. As a result, the operation of the injection molding machine 4 can be suspended before molding defects increase, or the injection molding machine 4 can be placed in a safe standby state to prevent damage.

The state determination device 1 according to the present embodiment having the above configuration can determine a molding state that gradually changes over a long period of time, and can predict future changes in the state. For example, when accident impact is applied to the sensors 5 or noise is added to the physical quantity detected by the sensors 5, the feature amount calculated by the feature amount calculation unit 110 may include an outlier. Statistical data calculated using a statistical condition for the feature amount including this outlier becomes a value less affected by the outlier of the feature amount or a value from which the outlier of the feature amount is removed, and thus it is possible to accurately determine the gradually changing molding state. In addition, in the state determination device 1 according to the present embodiment, by making a determination using a change state of statistics obtained from a plurality of molding cycles, it is possible to understand transition of the molding state that changes little by little over time, and a sign of an abnormality is detected before the abnormality (alarm) occurs to notify the operator of the sign of the abnormality. In other words, the operator is notified before the injection molding machine breaks down and the operator is notified before a defect occurs in the molded product, that is, abnormality detection and preventive maintenance are realized. Since it is possible to detect the presence or absence of an abnormality before suspension of production due to the abnormality, the operating rate is improved, the cost is reduced, and the work efficiency is improved. For example, before abrasion of a screw or a mold progresses to cause a molding defect, the operator can detect the presence or absence of the abnormality, and it is possible to perform maintenance work such as preparing a maintenance part before the member breaks down or replacing the member with a maintenance part. In this way, stable and reproducible determination based on numerical information is realized rather than determination of the presence or absence of an abnormality depending on experience and intuition of the operator.

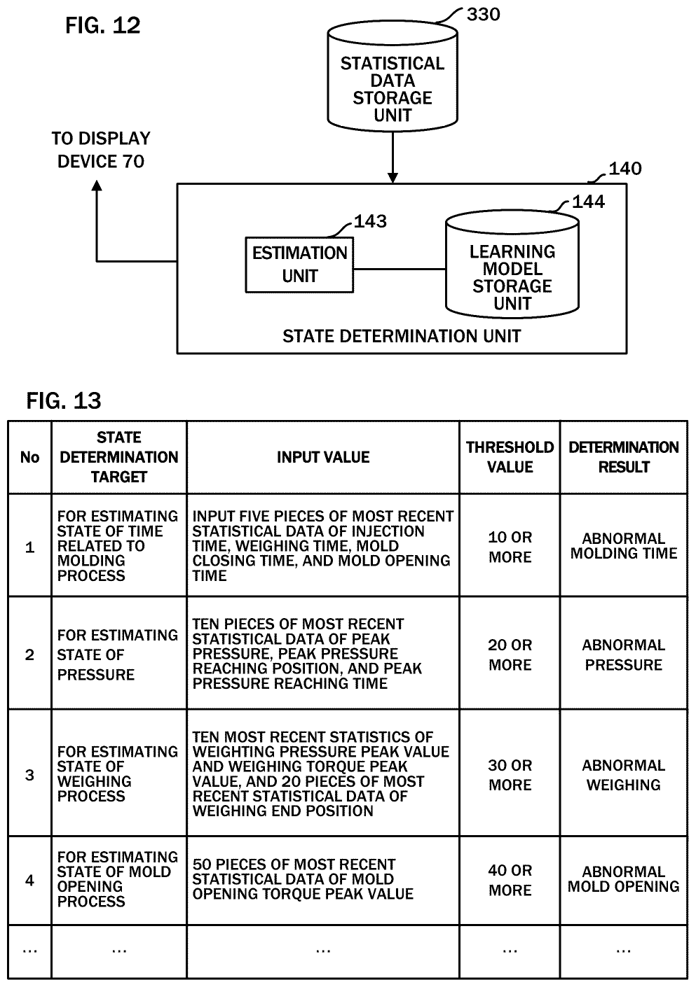

As a modified example of the state determination device 1 according to the present embodiment, the state determination unit 140 may use machine learning technology to determine fluctuation in a plurality of pieces of consecutive statistical data stored in the statistical data storage unit 330. FIG. 12 is a schematic block diagram illustrating a function of the state determination unit 140 when determining fluctuation based on an estimation result using machine learning technology. The state determination unit 140 that performs determination by machine learning includes an estimation unit 143 and a learning model storage unit 144.

The estimation unit 143 uses a learning model stored in the learning model storage unit 144 to perform state estimation based on a plurality of pieces of consecutive statistical data. FIG. 13 illustrates an example of a learning model stored in the learning model storage unit 144. The learning model stored in the learning model storage unit 144 performs learning using statistical data calculated based on data acquired in advance from each of the injection molding machine 4 operating normally and the injection molding machine 4 exhibiting an abnormality. For example, the learning model may perform learning using known supervised learning. In this case, as a machine learning algorithm, it is possible to use a known one such as a multi-layer perceptron, a regression-connection neural network, or a convolutional neural network. The definition of label data and a threshold value used to determine the state differ depending on the target of state determination, the type of machine learning algorithm, etc., and thus it is preferable to set an appropriate value by repeating a test operation in advance. For example, in the example of FIG. 13, a learning model (learning model No. 1) “for estimating a state of a time related to the molding process” is a learning model performing learning using teacher data in which “five pieces of most recent statistical data of the injection time, the weighing time, the mold closing time, and the mold opening time” acquired from the injection molding machine 4 in advance are set as input data, and a percentage (0 to 100%) of increase to a normal value of a time related to manufacture of the molded product is set as output data (label data). Each time new statistical data is calculated, the estimation unit 143 acquires five pieces of most recent consecutive statistical data for each of the injection time, the weighing time, the mold closing time, and the mold opening time, inputs the acquired statistical data to the learning model described above, and acquires output thereof (an estimate of an abnormality degree). Then, when the estimated abnormality degree is equal to or greater than 10, which is a threshold value, the state determination unit 140 determines that there is an abnormality in the molding time. In another example of FIG. 13, a learning model (learning model No. 3) “for estimating a state of the weighing process” is a learning model that performs learning using teacher data in which “ten pieces of most recent statistical data of the weighing pressure peak value and the weighing torque peak value, and 20 pieces of most recent statistical data of the weighing end position” acquired from the injection molding machine 4 in advance are set as input data, and a label (0 to 100%) indicating a divergence degree from a normal value of a weight of the molded product is set as output data (label data). Each time new statistical data is calculated, the estimation unit 143 acquires ten pieces of most recent consecutive statistical data of the weighing pressure peak value and the weighing torque peak value, and 20 pieces of most recent consecutive statistical data of the weighing end position, inputs the acquired statistical data to the learning model described above, and acquires output thereof (an estimate of an abnormality degree). Then, when the estimated abnormality degree is equal to or greater than 30, which is a threshold value, the state determination unit 140 determines that there is an abnormality in the weighing process. In this way, the learning model that performs learning using a series of a plurality of pieces of consecutive statistical data as input data becomes a model that has learned a correlation between fluctuation among the plurality of pieces of statistical data and the state of the injection molding machine 4 (state of the molded product).

For example, the learning model may be based on known unsupervised learning. In this case, a known machine learning algorithm such as an autoencoder or k-means method can be used. In addition, for example, the learning model may be based on known reinforcement learning. In this case, a known machine learning algorithm such as Q learning can be used.

The learning model may be stored in the learning model storage unit 144 in a compressed state, and decompressed for use during an estimation process. In this way, since a storage memory of the state determination device can be efficiently used, and a small amount of storage memory can be used, there is an advantage of cost reduction. The learning model may be encrypted and stored in the learning model storage unit 144, and may be decrypted and used in the estimation process. In this way, the state determination device 1 has an advantage of security and information confidentiality.

It is possible to create a learning model having a different feature depending on the type of learning data and the difference in learning algorithm. Different learning models may be prepared and properly used in consideration of features and differences such as calculation load (calculation time), accuracy of an estimate, and robustness (stability, universality) to time-series data. In this case, a plurality of different learning models may be created in advance for a state to be determined, and an appropriate learning model may be properly used according to a situation such that, for example, a learning model having a low calculation load is selected when a calculation load of the state determination device 1 is high, or a learning model having high estimation accuracy even if the calculation load is high is selected when accuracy of an estimate is required.

In this way, the state determination device 1 using machine learning technology can determine the molding state that gradually changes over a long period of time, and can predict a future change in the state. By using machine learning technology, unlike a method based on statistical analysis, a correlation between statistical data and a state change is learned in advance as a learning model, so that the cost of analyzing a relationship therebetween in advance can be reduced.

Even though one embodiment of the present invention has been described above, the invention is not limited to the above-described examples of the embodiment, and can be implemented in various modes by adding appropriate modifications.

For example, when a plurality of injection molding machines 4 is interconnected via the network 9, data may be acquired from the plurality of injection molding machines, and a state of each injection molding machine may be determined by one state determination device 1, or the state determination device 1 may be disposed on each of controllers provided in the plurality of injection molding machines, and a state of each injection molding machine may be determined by each state determination device provided in the injection molding machine.

### EXPLANATIONS OF LETTERS OR NUMERALS

1 STATE DETERMINATION DEVICE
2 MACHINE LEARNING DEVICE
3 CONTROLLER
4 INJECTION MOLDING MACHINE
5 SENSOR
6 FOG COMPUTER
7 CLOUD SERVER
9 NETWORK
11 CPU
12 ROM
13 RAM
14 NONVOLATILE MEMORY
15, 17, 18, 20 INTERFACE
22 BUS
70 DISPLAY DEVICE
71 INPUT DEVICE
72 EXTERNAL DEVICE
100 DATA ACQUISITION UNIT
110 FEATURE AMOUNT CALCULATION UNIT
120 STATISTICAL DATA CALCULATION UNIT
140 STATE DETERMINATION UNIT
141 STATISTICAL ANALYSIS UNIT
142 DETERMINATION CONDITION STORAGE UNIT
143 ESTIMATION UNIT
144 LEARNING MODEL STORAGE UNIT
300 ACQUIRED DATA STORAGE UNIT
310 FEATURE AMOUNT STORAGE UNIT
320 STATISTICAL CONDITION STORAGE UNIT
330 STATISTICAL DATA STORAGE UNIT

1. A state determination device for determining a state of an injection molding machine, the state determination device comprising:
a data acquisition unit configured to acquire data related to a predetermined physical quantity as data indicating a state related to the injection molding machine;
a feature amount calculation unit configured to calculate a feature amount indicating a feature of a state of the injection molding machine based on the data related to the physical quantity;
a feature amount storage unit configured to store the feature amount;
a statistical condition storage unit configured to store a statistical condition including at least a statistical function for calculating a predetermined statistic from a predetermined feature amount;
a statistical data calculation unit configured to calculate a statistic as statistical data with reference to a statistical condition stored in the statistical condition storage unit based on the feature amount stored in the feature amount storage unit;
a statistical data storage unit configured to store the statistical data; and
a state determination unit configured to determine a state of the injection molding machine based on fluctuation of a plurality of pieces of consecutive statistical data in the statistical data stored in the statistical data storage unit.

2. The state determination device according to claim 1, wherein:
the state determination unit includes:
a determination condition storage unit configured to store a determination condition for determining a state of the injection molding machine; and
a statistical analysis unit configured to statistically analyze whether or not a plurality of pieces of consecutive statistical data stored in the statistical data storage unit satisfies a determination condition stored in the determination condition storage unit, and
a state of the injection molding machine is determined based on an analysis result of the statistical analysis unit.

3. The state determination device according to claim 2, wherein the determination condition defines a condition related to any one of the monotonically increasing number of times, the monotonically decreasing number of times, an increase rate, and a decrease rate of a plurality of pieces of consecutive statistical data.

4. The state determination device according to claim 1, wherein the state determination unit includes:
a learning model storage unit configured to store a learning model learning a correlation between a plurality of pieces of consecutive statistical data in the statistical data calculated by the statistical data calculation unit and a state of the injection molding machine when the statistical data is calculated; and
an estimation unit configured to estimate a state of the injection molding machine using the learning model based on a plurality of pieces of consecutive statistical data stored in the statistical data storage unit.

5. The state determination device according to claim 4, wherein the learning model performs learning using at least one learning method among supervised learning, unsupervised learning, and reinforcement learning.

6. The state determination device according to claim 1, wherein the statistical function is any one of a variance, a standard deviation, an average deviation, a coefficient of fluctuation, a weighted mean, a weighted harmonic mean, a trimmed mean, a root mean square, a minimum value, a maximum value, a mode value, and a weighted median value.

7. The state determination device according to claim 1, wherein a result of determination by the state determination unit is displayed on and output to a display device.

8. The state determination device according to claim 1, wherein, when the state determination unit determines that a state of the injection molding machine is abnormal, at least one of signals for suspending or decelerating an operation of the injection molding machine or limiting driving torque of a prime mover driving the injection molding machine is output.

9. The state determination device according to claim 1, wherein the data acquisition unit acquires data from a plurality of injection molding machines connected via a wired or wireless network.

10. The state determination device according to claim 1, wherein the state determination device is mounted on a host device connected to the injection molding machine via a wired or wireless network.

11. A state determination method of determining a state of an injection molding machine, the state determination method executing:
a step of acquiring data related to a predetermined physical quantity as data indicating a state related to the injection molding machine;
a step of calculating a feature amount indicating a feature of a state of the injection molding machine based on data related to the physical quantity;
a step of calculating a statistic as statistical data according to a statistical condition including at least a statistical function for calculating a predetermined statistic from a predetermined feature amount based on the calculated feature amount; and
a step of determining a state of the injection molding machine based on fluctuation of a plurality of pieces of consecutive statistical data in the calculated statistical data.
